(19) United States
(12) Patent Application Publication
(10) Pub. No.: US 2022/0029527 A1
(43) Pub. Date: Jan. 27, 2022

(54) CONVERTER ARRANGEMENT AND METHOD FOR THE OPERATION THEREOF

(71) Applicant: SIEMENS ENERGY GLOBAL GMBH & CO. KG, MUENCHEN (DE)

(72) Inventors: FABIAN HASSEL, ERLANGEN (DE); FELIX KAMMERER, ERLANGEN (DE)

(21) Appl. No.: 17/311,417

(22) PCT Filed: Dec. 5, 2018
(86) PCT No.: PCT/EP2018/083673

§ 371 Date: Jun. 7, 2021

(51) Int. Cl. H02M 1/32; H02M 7/483; H02M 1/00; H02M 7/5387

(52) U.S. Cl. CPC H02M 1/325; H02M 7/5387; H02M 1/0009; H02M 7/4835

(57) ABSTRACT

A method is provided for operating a converter arrangement having a modular multilevel converter which includes at least one series circuit of double-pole switch modules, of which at least one first switch module is a full bridge switch module including controllable semiconductor switches and an energy storage device. The switches and the energy storage device are connected to one another in a full bridge circuit. After one of the semiconductor switches in the first switch module has been found to be defective, the first switch module continues to be operated as a half bridge switch module. A converter arrangement for carrying out the method is also provided.

The invention relates to a method for operating a converter arrangement with a modular multilevel converter which comprises at least one series connection of double-pole switch modules, of which at least one first switch module is a full bridge switch module which has controllable semiconductor switches as well as an energy storage device, which are connected to one another in a full bridge circuit.

Converter arrangements with modular multilevel converters are known from the prior art. In one basic structure, the modular multilevel converter (MMC) comprises a plurality of converter arms. If the MMC is used in an application for reactive power compensation, the converter arms can be connected to one another, for example in a delta connection or star connection. If the MMC is used for converting AC voltage and DC voltage, or vice versa, the converter arms can in each case be arranged between an allocated DC voltage pole and an AC voltage connection of the MMCs. In this case, each converter arm comprises a series connection of double-pole switch modules which each comprise controllable semiconductor switches as well as an energy storage device. The types of switch modules which are commonly used are half bridge switch modules and full bridge switch modules. Each of the switch modules of the modular multilevel converter can be controlled individually by means of a control device. A voltage which drops at one of the converter arms is equal to the sum of voltages which drop at the associated switch modules. A particularly advantageous stepped converter voltage can be generated by means of the MMC.

A full bridge switch module is characterized in particular by the fact that a positive switch module voltage, a negative switch module voltage or a zero voltage can be generated at its two connecting terminals. The switch module voltage corresponds, according to its magnitude, to an energy storage voltage which is present at the energy storage device of the switch module. By contrast, a half bridge switch module is characterized by the fact that a positive switch module voltage or a zero voltage can be generated at its two connecting terminals, in the case of a half bridge switch module with a positive voltage. In a different configuration of the semiconductor switches of the half bridge switch module, a negative switch module voltage or a zero voltage can be generated at its two connecting terminals.

In the case of a fault in one of the switch modules of the MMC, it is necessary in the case of the known converter arrangements for their continued operation for the faulty switch module to be bypassed by means of a suitable bypass switch. This disadvantageously results in the number of installed switch modules being selected to be higher than would be necessary for the voltage requirements. On the other hand, a faulty switch module can result in a higher DC current on an AC voltage side of the MMC. This can lead to malfunctioning of further components of the converter arrangement, such as to a saturation of a power transformer, for example. In the case of the known converter arrangements, the faulty switch module must be replaced, since usually it cannot be repaired. This disadvantageously increases the operational costs of the converter arrangement.

The object of the invention is to specify a suitable method which permits the converter arrangement to be operated in a manner which is as cost effective and reliable as possible.

The object is achieved according to the invention by a method mentioned at the outset in which the first switch module continues to be operated as a half bridge switch module after one of the semiconductor switches in the first switch module has been detected as being faulty. The switch module which is faulty or is identified as being faulty therefore continues to be operated with a reduced function. In particular, the faulty switch module does not necessarily have to be bypassed in order to ensure the continued operation of the converter arrangement. A central control unit for controlling the MMC suitably takes over an adapted control of the faulty switch module. According to the invention, it has been identified that a full bridge switch module, the semiconductor switch of which is defective, can be operated as a half bridge switch module by suitable switching states of the switch module not being used by the control unit, for example, others in turn being permitted. For example, a first switching state, in which a positive switch module voltage is generated at the connecting terminals of the first switch module, as well as a second switching state, in which a zero voltage is generated at the connecting terminals, can continue to be used or generated by the control device. A third switching state, in which a negative switch module voltage is generated in the case of a non-defective switch module at its connecting terminals, is locked in this case and is not used. In this case, the specified switching states are generated by the semiconductor switches of the switch module being transferred into a locked or an open state in a suitable and defined manner. Locking or opening the semiconductor switches advantageously takes place by means of a control assembly of the switch module which receives control signals from the central control device and correspondingly converts them in a manner which is known to the person skilled in the art. In this case, it should be noted that the term “first switch module” is used purely for nomenclatural purposes, i.e. in general there are in particular no prerequisites with respect to the arrangement or placement of the first switch module within the converter arrangement. Conforming to this, the method can be applied to a second and/or further switch modules which are full bridge switch modules, for example.

The method according to the invention has the advantage that the reliability of the converter arrangement can be increased since even in the event of a fault in a switch module, a continued operation of this switch module is possible. In addition, undesired effects as a result of defective switch modules on a network connected to the converter arrangement can be minimized. The voltage design of the converter arrangement can therefore be optimized, whereby the operational costs thereof may be advantageously reduced.

For detecting the fault, a switch module response is preferably considered which has been sent from a control assembly of the first switch module to a central control device of the multilevel converter. The first switch module, particularly preferably each switch module of the MMC, therefore sends switch module responses to the central control device. The switch module responses are signals which can include specific measurement values and further information. The switch module response can be transmitted to the control device as an electrical signal or light signal by means of a control assembly of the switch module, for example. The presence of a fault in the first switch module can be determined on the basis of the switch module response. However, it is also conceivable that the switch module response itself already includes information regarding a fault. If the switch module responses are transmitted at short intervals (for example with a frequency in the kilohertz or megahertz range), this enables fast fault detection. It is possible for the switch module response to be sent on request or demand by way of the central control device or automatically and unprompted by way of the switch module. In general, the fault detection based on the switch module response enables automatic fault detection which can be carried out during operation of the converter arrangement.

The switch module response preferably comprises a current measurement value and/or voltage measurement value measured at the switch module and/or at one or a plurality of the semiconductor switches. It is possible to determine whether and which of the semiconductor switches is faulty in a particularly simple and reliable manner from the voltage or the current at the semiconductor switches.

A fault state of the faulty semiconductor switch can advantageously be determined and, depending on the determined fault state, the first switch module is operated as a half bridge switch module with a positive voltage or as a half bridge switch module with a negative voltage. Whether the first switch module continues to be operated as a half bridge switch module with a positive voltage or as a half bridge switch module with a negative voltage is therefore decided based on which of the semiconductor switches is defective and what the fault state of the faulty semiconductor switch is. In this case, the fault state specifies in particular whether the faulty semiconductor switch is permanently locked, i.e. cannot conduct a current, or permanently open, i.e. conducts current in any case. In the case of a half bridge switch module with a positive voltage, a first switching state, in which a positive switch module voltage is generated at the connecting terminals of the first switch module, as well as a second switching state, in which a zero voltage is generated at the connecting terminals, can be used or generated. A third switching state, in which a negative switch module voltage is generated in the case of a non-defective switch module at its connecting terminals, is not used. In the case of a half bridge switch module with a negative voltage, the second as well as the third switching state are used, while the first switching state is not used. The switching states which are used can be realized by means of suitable control of the semiconductor switches. This method makes it possible to use the faulty switch module in a particularly effective manner.

According to one embodiment of the invention, the first switch module comprises a first disconnectable semiconductor switch to which a first free-wheeling diode is connected in antiparallel, a second disconnectable semiconductor switch to which a second free-wheeling diode is connected in antiparallel, wherein the first and the second semiconductor switches are connected to one another in a first semiconductor series connection and have the same direction of flow, a third disconnectable semiconductor switch to which a third free-wheeling diode is connected in antiparallel, a fourth disconnectable semiconductor switch to which a fourth free-wheeling diode is connected in antiparallel, wherein the third and the fourth semiconductor switches are connected to one another in a second semiconductor series connection and have the same direction of flow, wherein the two semiconductor series connections are arranged in parallel to one another and to the energy storage device, and the first switch module further has a first connecting terminal which is arranged between the semiconductor switches of the first semiconductor series connection, and a second connecting terminal which is arranged between the semiconductor switches of the second semiconductor series connection, wherein the first switch module is operated as a half bridge switch module with a positive voltage, in the event that the second or the third semiconductor switch is locked in a faulty and permanent manner or the first or the fourth semiconductor switch is open in a faulty and permanent manner (i.e. permanently conductive), wherein the first switch module is operated as a half bridge switch module with a negative voltage, in the event that the second or the third semiconductor switch is open in a faulty and permanent manner or else the first or the fourth semiconductor switch is locked in a faulty and permanent manner. The first switch module therefore comprises four pairs each with a semiconductor switch and free-wheeling diodes which are arranged thereto in antiparallel, and which are arranged in two series connections which are connected in parallel to the energy storage device.

The energy storage voltage at the energy storage device of the first switch module is preferably monitored. This information can advantageously be used to form a symmetry of the voltages in the MMC. Monitoring suitably takes place by means of a voltage measurement at the energy storage device. The corresponding information can be transmitted to the central control unit, for example by means of the switch module response. In particular, the energy storage voltage of the faulty switch module can advantageously be used when symmetrizing the energy storage devices of the remaining switch modules. Symmetrizing improves the reliability of the converter arrangement, since overvoltages and undervoltages at individual switch modules can be avoided in this way. Symmetrizing can comprise taking into account the energy storage voltage of one of the switch modules during its control, for example, such that the energy input and output is regulated accordingly, so that, as far as possible, overvoltages or undervoltages do not occur.

According to one embodiment of the invention, before switching one of the switch modules, a selection is made as to which of the switch modules will be switched next, wherein the selection takes into account whether the first switch module is operated as a half bridge switch module with a positive voltage or as a half bridge switch module with a negative voltage. The selection can be used for the symmetrizing already mentioned of the energy storage voltages, for example. The first switch module which is used as a half bridge switch module with a positive voltage is only controlled or taken into account for the selection if a positive converter voltage is to be generated, for example. Correspondingly, a first switch module which is used as a half bridge switch module with a negative voltage is only controlled or taken into account for the selection if a negative converter voltage is to be generated, for example. The selection advantageously takes place by means of the central control device. Switching the switch module comprises transferring the switch module from a given switching state to a switching state which deviates therefrom, whereby the switch module voltage which is present at the connecting terminals is established.

The invention further relates to a converter arrangement with a modular multilevel converter which comprises at least one series connection of double-pole switch modules, of which at least one first switch module is a full bridge switch module which has controllable semiconductor switches as well as an energy storage device, which are connected to one another in a full bridge circuit, and with a central control device.

The object of the invention is to propose a converter arrangement of this type which is as cost effective and reliable as possible in operation.

In the case of a suitable converter arrangement, the object is achieved according to the invention by the control device being set up to continue to operate the first switch module as a half bridge switch module after one of the semiconductor switches in the first switch module has been detected as being faulty.

The advantages of the converter arrangement according to the invention are derived in particular from the advantages described previously in relation to the method according to the invention.

According to one embodiment of the invention, the converter arrangement comprises a transformer, by means of which the converter arrangement can be connected to an AC voltage network. One particular advantage of this design is derived from the fact that it is possible to avoid an undesired saturation of the transformer by means of the converter arrangement, since additional DC currents can be avoided by continuing to operate faulty switch modules.

The first switch module preferably comprises a bypass switch, by means of which the first switch module can be bypassed, wherein the bypass switch is connected to the two connecting terminals of the first switch module. In the event that a defect in the first switch module is so severe that it can no longer be operated, in particular not as a half bridge switch module, the first switch module can be bypassed, so that the MMC can generally continue—in a limited manner—to perform its function.

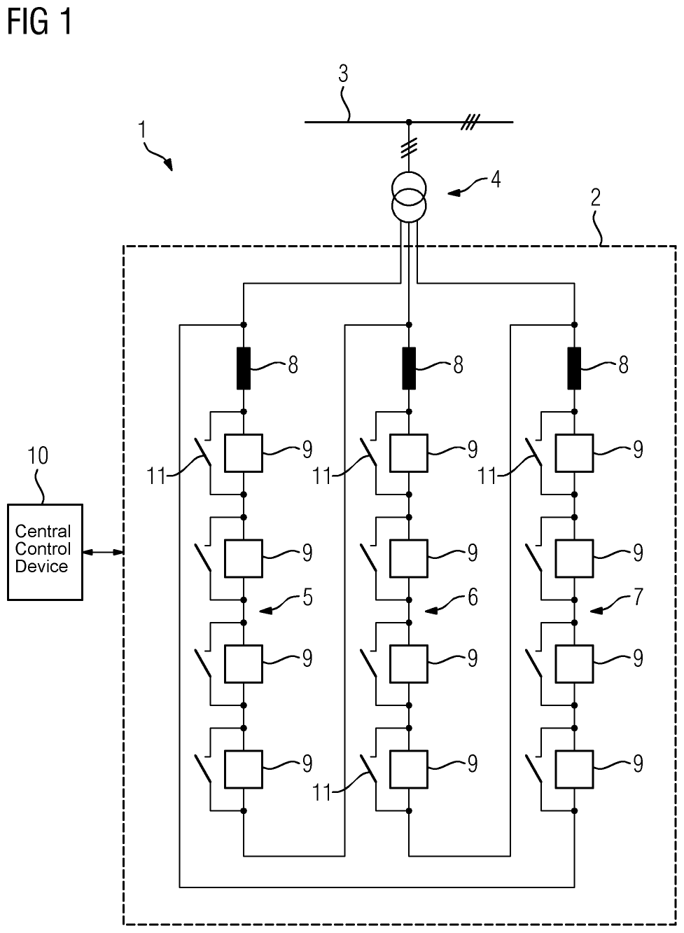

The invention is explained hereinafter using FIGS. 1 to 34.

FIG. 1 shows an exemplary embodiment of a converter arrangement according to the invention in a schematic representation;

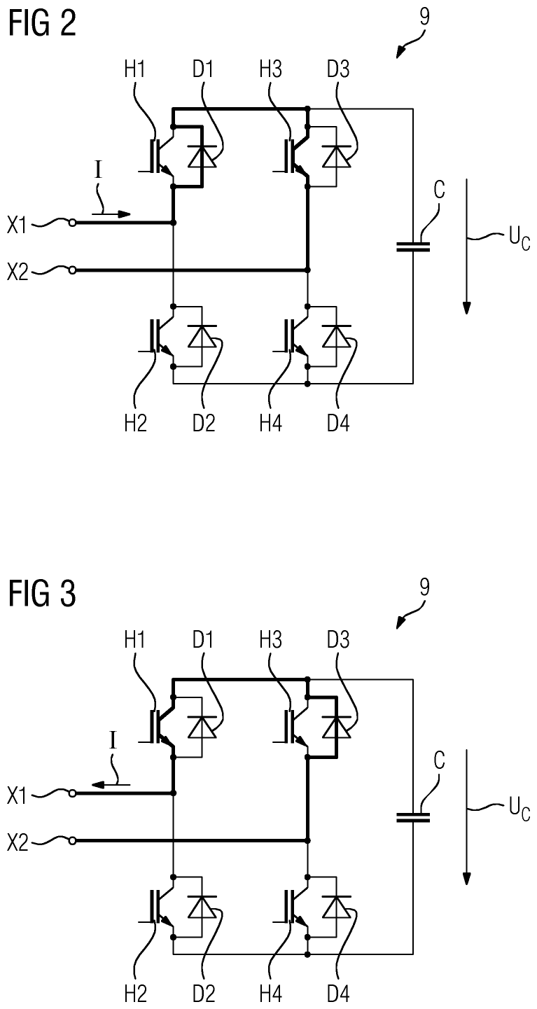

FIGS. 2 to 33 describe switching states of a switch module for the converter arrangement from FIG. 1 in a schematic representation in each case;

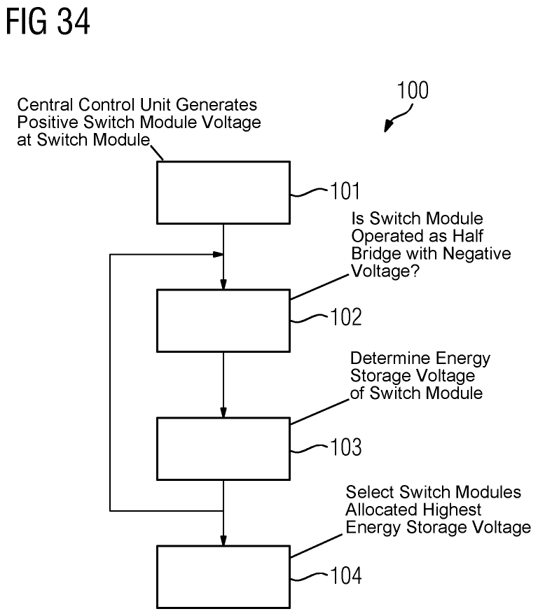

FIG. 34 shows an exemplary embodiment of a method according to the invention in a schematic flow diagram.

FIG. 1 represents a converter arrangement 1. The converter arrangement 1 comprises a modular multilevel converter (MMC) 2 which, in the example represented, is set up to stabilize an AC voltage network 3 to which the MMC 2 is connected by means of a power transformer 4.

The MMC 2 comprises a first, a second as well as a third converter arm 5, 6 or 7 which are connected to one another in a delta connection. Each of the converter arms 5-7, which are structured in the same way, comprises an arm inductance 8 as well as a series connection of double-pole switch modules 9. In the exemplary embodiment represented in FIG. 1, all switch modules 9 are structured in the same way, which, however, is generally not necessary. The number of switch modules 9 in each converter arm 5-7 is also essentially arbitrary and can be adapted for the respective application. The switch modules 9 are full bridge switch modules, the structure of which is explored in greater detail in the subsequent figures. Each switch module 9 comprises controllable semiconductor switches, for example an IGBT or the like, an energy storage device as well as a control assembly, by means of which the semiconductor switches can be controlled.

The converter arrangement 1 further comprises a central control device 10 which is set up to regulate the MMC 2 and to control the switch modules 9. According to a time cycle, the control device 10 selects which of the switch modules 9 will be switched next in each converter arm 5-7. The control device 10 then sends a corresponding signal to the control assembly of the relevant switch module 9, the semiconductors of which are controlled in a suitable manner in order to generate the required switching state of the switch module 9. A bypass switch 11 is provided in each case for bypassing the switch modules 9.

The central control unit 10 receives a switch module response from each switch module 9 via the control assembly thereof. The switch module response can be used by the control device 10 to determine whether and which of the switch modules 9 is faulty. Moreover, the control device 10 determines which of the semiconductor switches of the faulty switch module 9 has failed and in which fault state the faulty semiconductor switch finds itself (permanently locked (OFF) or permanently open (ON)).

Based on the information determined, the control device 10 can subsequently decide to continue to operate the faulty switch module as a half bridge switch module. In the event that the fault is so severe that this is not possible, the relevant switch module can be bypassed and the MMC 2 can continue to be operated without this switch module.

The subsequent figures illustrate concrete possibilities for generating one of the switching states at the switch module, namely depending on which of the semiconductor switches is faulty and in which fault state this semiconductor switch finds itself. In this case, one switching state is referred to as a first switching state in which a switch module voltage is generated at its connecting terminals X1, X2 which corresponds to a positive energy storage voltage Uc. One switching state is referred to as a second switching state in which a switch module voltage is generated at its connecting terminals X1, X2 which corresponds to a zero voltage. One switching state is referred to as a third switching state in which a switch module voltage is generated at its connecting terminals X1, X2 which corresponds to a negative energy storage voltage −Uc.

The structure of the switch module 9 is explained with reference to FIG. 2. In order to avoid repetitions, only the states of the individual semiconductor switches H1-4 as well as the switching state of the switch module 9 are explored in FIGS. 3 to 33. The same and similar elements are provided with the same reference numbers in all of the figures specified.

The switch module 9 comprises a first disconnectable semiconductor switch H1 to which a first free-wheeling diode D1 is connected in antiparallel, a second disconnectable semiconductor switch H2 to which a second free-wheeling diode D2 is connected in antiparallel, wherein the first and the second semiconductor switches H1, H2 are connected to one another in a first semiconductor series connection and have the same direction of flow. The switch module 9 further comprises a third disconnectable semiconductor switch H3 to which a third free-wheeling diode D3 is connected in antiparallel, and a fourth disconnectable semiconductor switch H4 to which a fourth free-wheeling diode D4 is connected in antiparallel, wherein the third and the fourth semiconductor switches H3, H4 are connected to one another in a second semiconductor series connection and have the same direction of flow. The two semiconductor series connections are arranged in parallel to one another and to an energy storage device C at which an energy storage voltage Uc is present. Furthermore, the first switch module further comprises a first connecting terminal X1 which is arranged between the semiconductor switches H1, H2 of the first semiconductor series connection, and a second connecting terminal X2 which is arranged between the semiconductor switches H3, H4 of the second semiconductor series connection.

FIG. 2 represents the case in which the first semiconductor switch H1 is in a fault state ON (permanently open) and the switch module 9 is to assume the second switching state in the case of a positive current direction of a current I through the switch module 9. For this purpose, the second and the fourth semiconductor switches H2, H4 are locked and the third semiconductor switch H3 is opened. The current I thus flows via the first free-wheeling diode D1 and the third semiconductor switch H3.

FIG. 3 represents the case in which the first semiconductor switch H1 is in a fault state ON and the switch module 9 is to assume the second switching state in the case of a negative current direction of a current I through the switch module 9. For this purpose, the second, third and the fourth semiconductor switches H2, H3, H4 are locked. The current I thus flows via the third free-wheeling diode D3 and the first semiconductor switch H1.

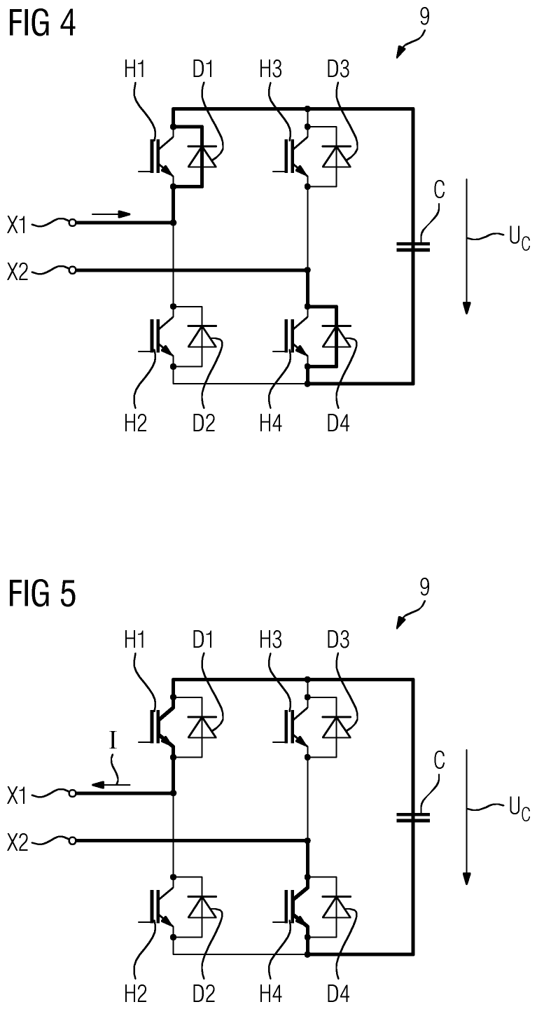

FIG. 4 represents the case in which the first semiconductor switch H1 is in a fault state ON and the switch module 9 is to assume the first switching state in the case of a positive current direction of a current I through the switch module 9. For this purpose, the second, third and the fourth semiconductor switches H2, H3, H4 are locked. The current I thus flows via the first and fourth free-wheeling diodes D1, D4.

FIG. 5 represents the case in which the first semiconductor switch H1 is in a fault state ON and the switch module 9 is to assume the first switching state in the case of a negative current direction of a current I through the switch module 9. For this purpose, the second and the third semiconductor switches H2, H3 are locked and the fourth semiconductor switch H4 is opened. The current I thus flows via the first and the fourth semiconductor switches H1, H4.

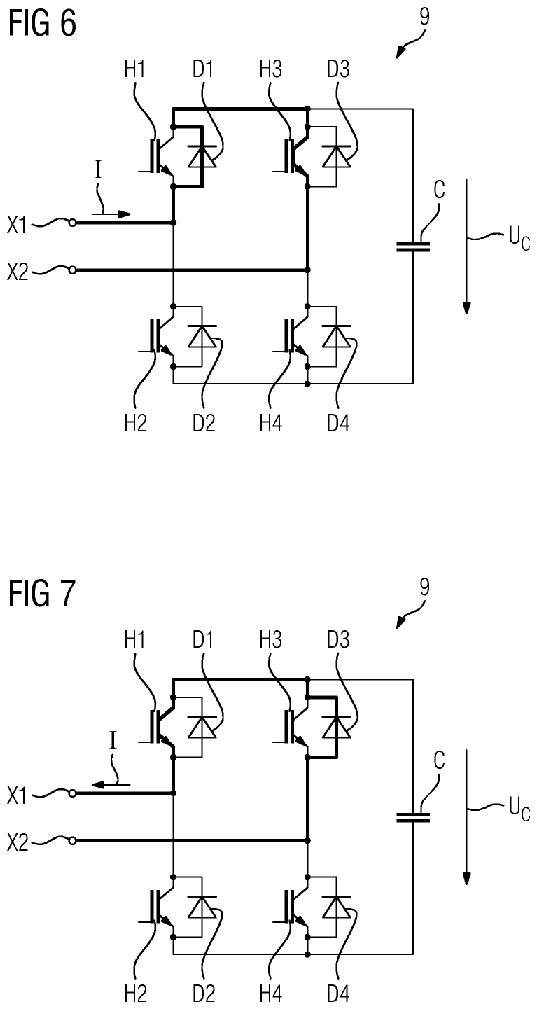

FIG. 6 represents the case in which the second semiconductor switch H2 is in a fault state OFF (permanently locked) and the switch module 9 is to assume the second switching state in the case of a positive current direction of a current I through the switch module 9. For this purpose, the first and the fourth semiconductor switches H1, H4 are locked and the third semiconductor switch H3 is opened. The current I thus flows via the first free-wheeling diode D1 and the third semiconductor switch H3.

FIG. 7 represents the case in which the second semiconductor switch H2 is in a fault state OFF and the switch module 9 is to assume the second switching state in the case of a negative current direction of a current I through the switch module 9. For this purpose, the third and the fourth semiconductor switches H3, H4 are locked and the first semiconductor switch H1 is opened. The current I thus flows via the third free-wheeling diode D3 and the first semiconductor switch H1.

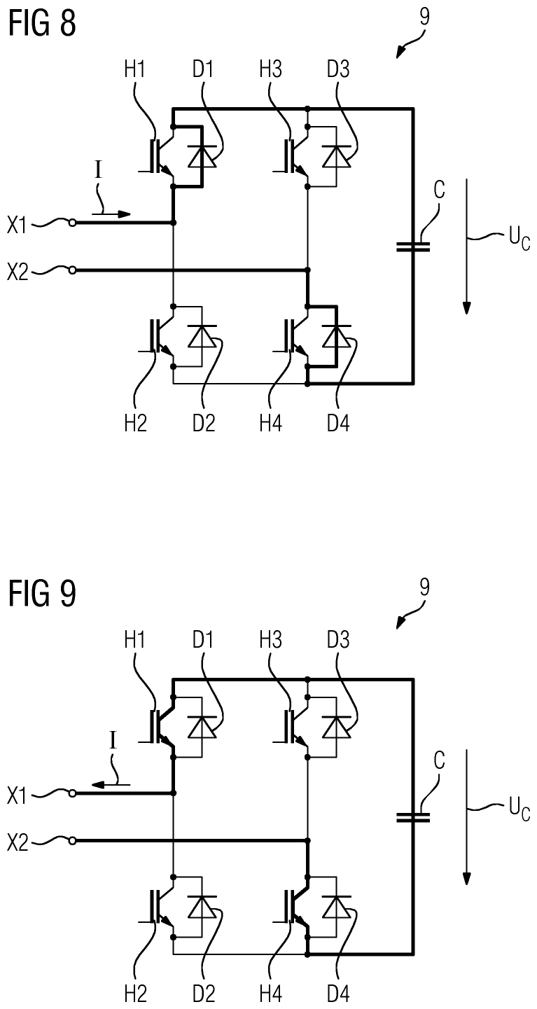

FIG. 8 represents the case in which the second semiconductor switch H2 is in a fault state OFF and the switch module 9 is to assume the first switching state in the case of a positive current direction of a current I through the switch module 9. For this purpose, the first, third and fourth semiconductor switches H1, H3, H4 are locked. The current I thus flows via the first and the fourth free-wheeling diodes D1 or D4.

FIG. 9 represents the case in which the second semiconductor switch H2 is in a fault state OFF and the switch module 9 is to assume the first switching state in the case of a negative current direction of a current I through the switch module 9. For this purpose, the first and the fourth semiconductor switches H2, H4 are opened and the third semiconductor switch H3 is locked. The current I thus flows via the first and the fourth semiconductor switches H1 or H4.

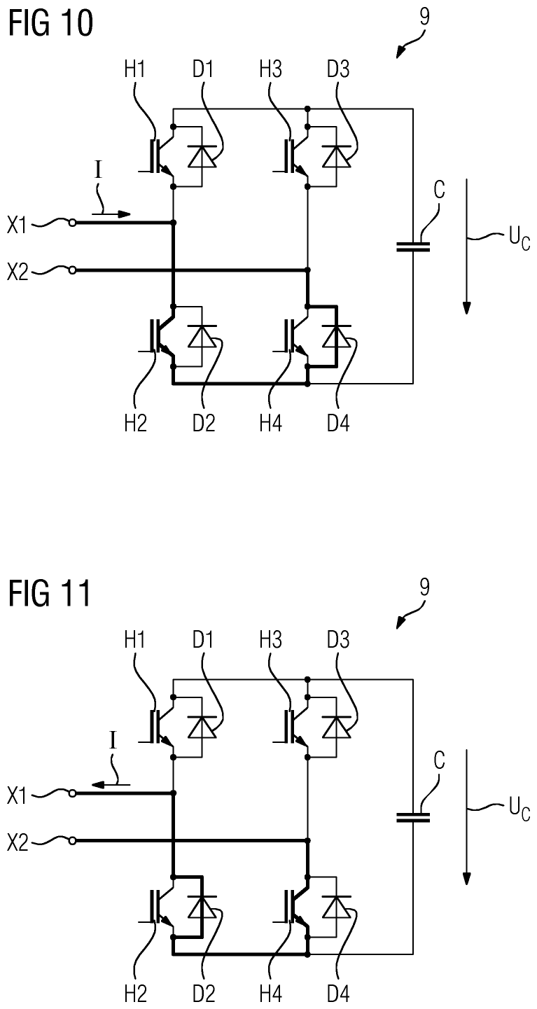

FIG. 10 represents the case in which the third semiconductor switch H3 is in a fault state OFF and the switch module 9 is to assume the second switching state in the case of a positive current direction of a current I through the switch module 9. For this purpose, the first and the fourth semiconductor switches H1, H4 are locked and the second semiconductor switch H2 is opened. The current I thus flows via the fourth free-wheeling diode D4 and the second semiconductor switch H2.

FIG. 11 represents the case in which the third semiconductor switch H3 is in a fault state OFF and the switch module 9 is to assume the second switching state in the case of a negative current direction of a current I through the switch module 9. For this purpose, the first and the second semiconductor switches H1, H2 are locked and the fourth semiconductor switch H2 is opened. The current I thus flows via the second free-wheeling diode D2 and the fourth semiconductor switch H4.

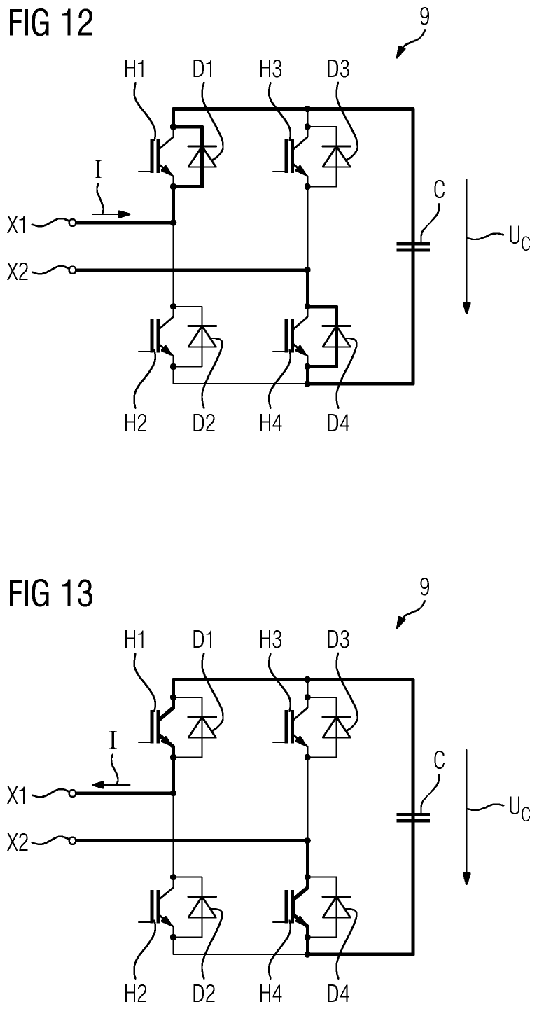

FIG. 12 represents the case in which the third semiconductor switch H3 is in a fault state OFF and the switch module 9 is to assume the first switching state in the case of a positive current direction of a current I through the switch module 9. For this purpose, the first, the second and the fourth semiconductor switches H1, H2, H4 are locked. The current I thus flows via the first and the fourth free-wheeling diodes D1, D4.

FIG. 13 represents the case in which the third semiconductor switch H3 is in a fault state OFF and the switch module 9 is to assume the second switching state in the case of a negative current direction of a current I through the switch module 9. For this purpose, the first and the fourth semiconductor switches H1, H4 are opened and the second semiconductor switch H2 is locked. The current I thus flows via the first and the fourth semiconductor switches H1 and H4.

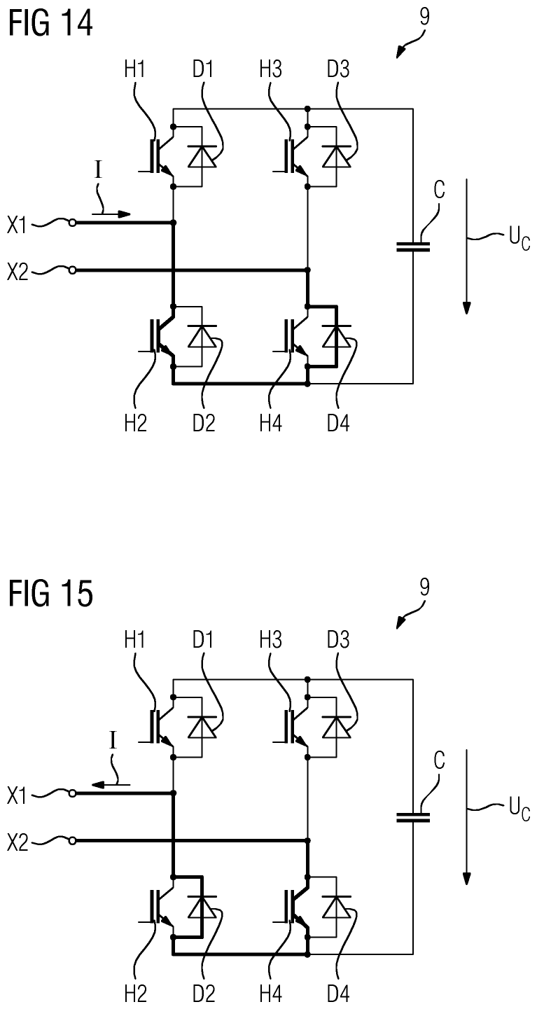

FIG. 14 represents the case in which the fourth semiconductor switch H4 is in a fault state ON and the switch module 9 is to assume the second switching state in the case of a positive current direction of a current I through the switch module 9. For this purpose, the first and the third semiconductor switches H1, H3 are locked and the second semiconductor switch H2 is opened. The current I thus flows via the fourth free-wheeling diode D4 and the second semiconductor switch H2.

FIG. 15 represents the case in which the fourth semiconductor switch H4 is in a fault state ON and the switch module 9 is to assume the second switching state in the case of a negative current direction of a current I through the switch module 9. For this purpose, the first, second and the third semiconductor switches H1, H2, H3 are locked. The current I thus flows via the second free-wheeling diode D2 and the fourth semiconductor switch H4.

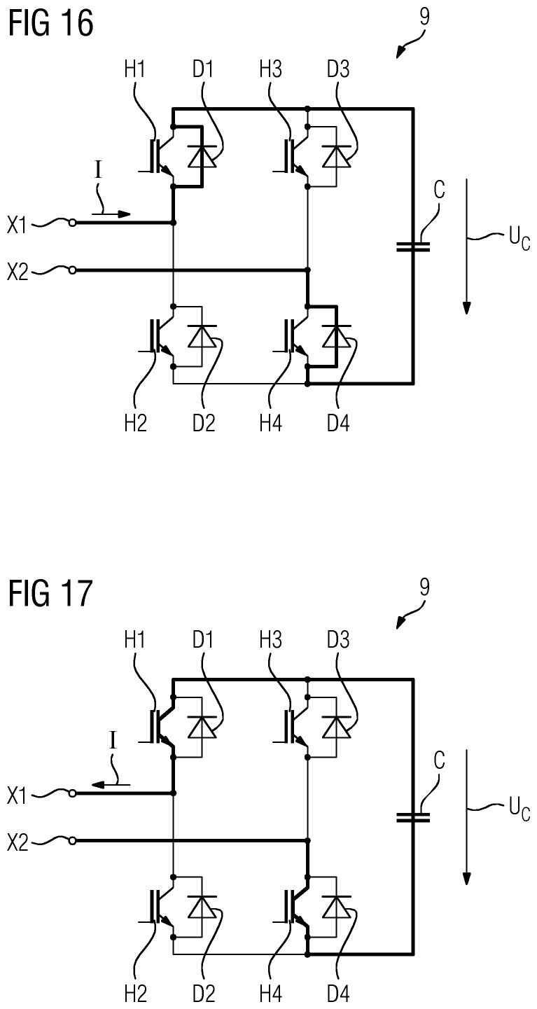

FIG. 16 represents the case in which the fourth semiconductor switch H4 is in a fault state ON and the switch module 9 is to assume the first switching state in the case of a positive current direction of a current I through the switch module 9. For this purpose, the first, second and the third semiconductor switches H1, H2, H3 are locked. The current I thus flows via the first and the fourth free-wheeling diodes D1, D4.

FIG. 17 represents the case in which the fourth semiconductor switch H4 is in a fault state ON and the switch module 9 is to assume the first switching state in the case of a negative current direction of a current I through the switch module 9. For this purpose, the second and the third semiconductor switches H2, H3 are locked and the first semiconductor switch H1 is opened. The current I thus flows via the first and the fourth semiconductor switches H1 or H4.

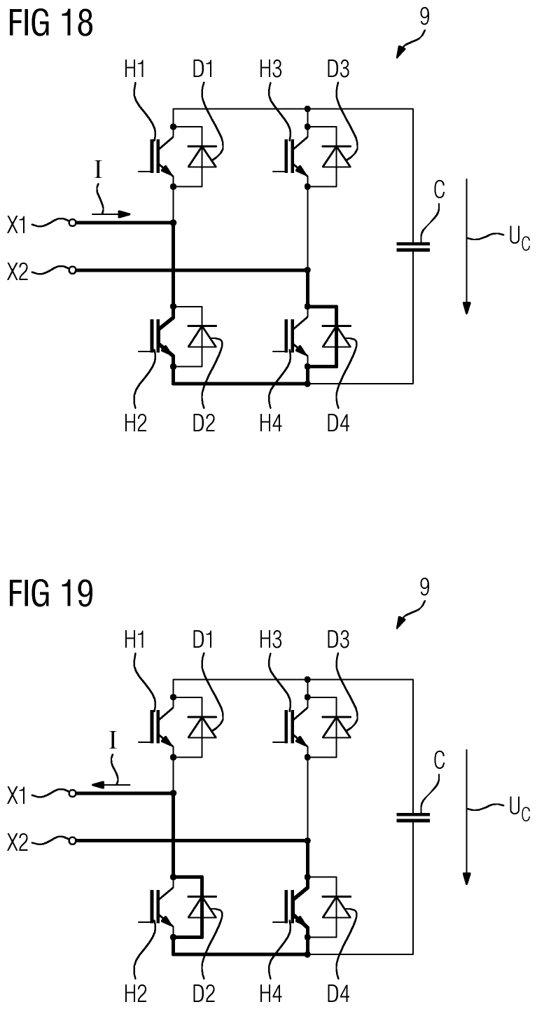

FIG. 18 represents the case in which the first semiconductor switch H1 is in a fault state OFF and the switch module 9 is to assume the second switching state in the case of a positive current direction of a current I through the switch module 9. For this purpose, the third and the fourth semiconductor switches H3, H4 are locked and the second semiconductor switch H2 is opened. The current I thus flows via the second semiconductor switch H2 and the fourth free-wheeling diode D4.

FIG. 19 represents the case in which the first semiconductor switch H1 is in a fault state OFF and the switch module 9 is to assume the second switching state in the case of a negative current direction of a current I through the switch module 9. For this purpose, the first and the second semiconductor switches H1, H2 are locked and the fourth semiconductor switch H4 is opened. The current I thus flows via the fourth semiconductor switch H4 and the second free-wheeling diode D2.

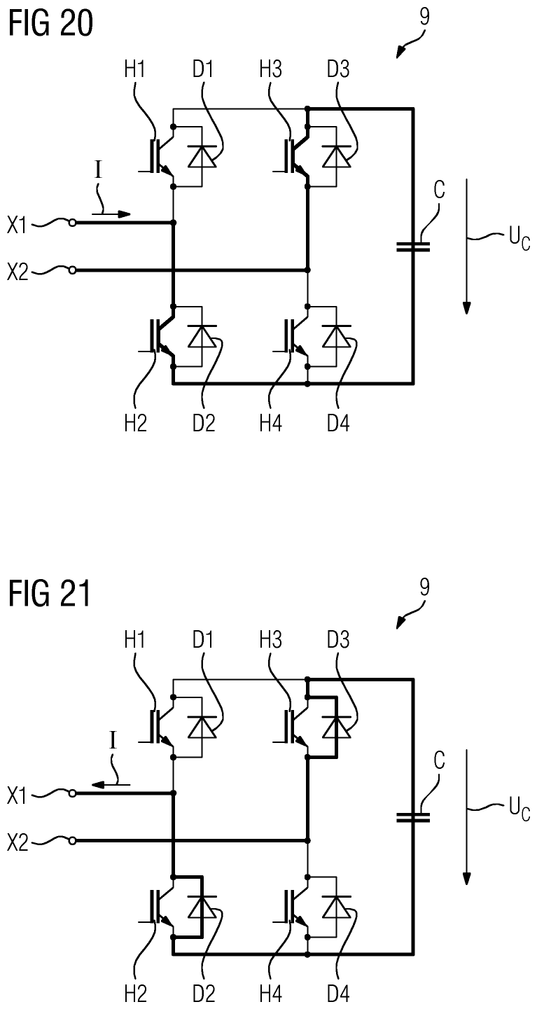

FIG. 20 represents the case in which the first semiconductor switch H1 is in a fault state OFF and the switch module 9 is to assume the third switching state in the case of a positive current direction of a current I through the switch module 9. For this purpose, the second and the third semiconductor switches H2, H3 are opened and the fourth semiconductor switch H4 is locked. The current I thus flows via the second and the third semiconductor switches H2 or H3.

FIG. 21 represents the case in which the first semiconductor switch H1 is in a fault state OFF and the switch module 9 is to assume the third switching state in the case of a negative current direction of a current I through the switch module 9. For this purpose, the second, the third and the fourth semiconductor switches H2, H3, H4 are locked. The current I thus flows via the second and the third free-wheeling diodes D2, D3.

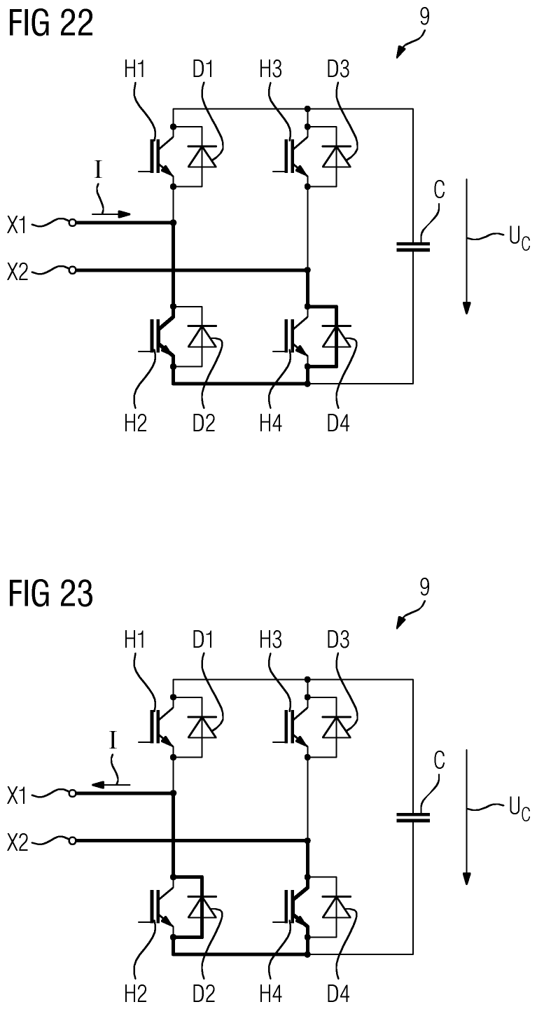

FIG. 22 represents the case in which the second semiconductor switch H2 is in a fault state ON and the switch module 9 is to assume the second switching state in the case of a positive current direction of a current I through the switch module 9. For this purpose, the first, the third and the fourth semiconductor switches H1, H3, H4 are locked. The current I thus flows via the fourth free-wheeling diode D4 and the second semiconductor switch H2.

FIG. 23 represents the case in which the second semiconductor switch H2 is in a fault state ON and the switch module 9 is to assume the second switching state in the case of a negative current direction of a current I through the switch module 9. For this purpose, the first and the second semiconductor switches H1 or H2 are locked and the fourth semiconductor switch H4 is opened. The current I thus flows via the second free-wheeling diode D2 and the fourth semiconductor switch H4.

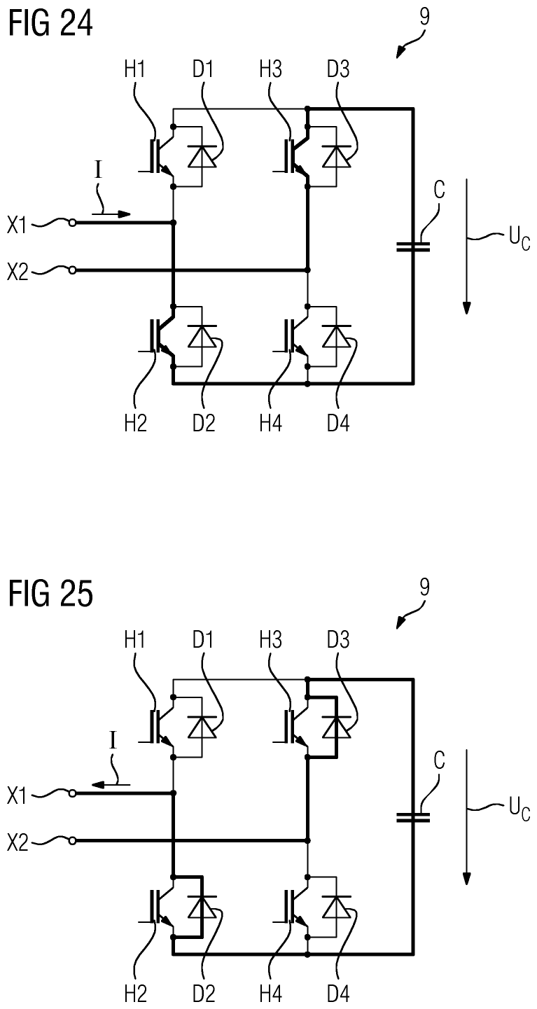

FIG. 24 represents the case in which the second semiconductor switch H2 is in a fault state ON and the switch module 9 is to assume the third switching state in the case of a positive current direction of a current I through the switch module 9. For this purpose, the first and the fourth semiconductor switches H1, H4 are locked and the third semiconductor switch H3 is opened. The current I thus flows via the second and the third semiconductor switches H2 or H3.

FIG. 25 represents the case in which the second semiconductor switch H2 is in a fault state ON and the switch module 9 is to assume the third switching state in the case of a negative current direction of a current I through the switch module 9. For this purpose, the first, the third and the fourth semiconductor switches H2, H3, H4 are locked. The current I thus flows via the third free-wheeling diode D3 and the second semiconductor switch H2.

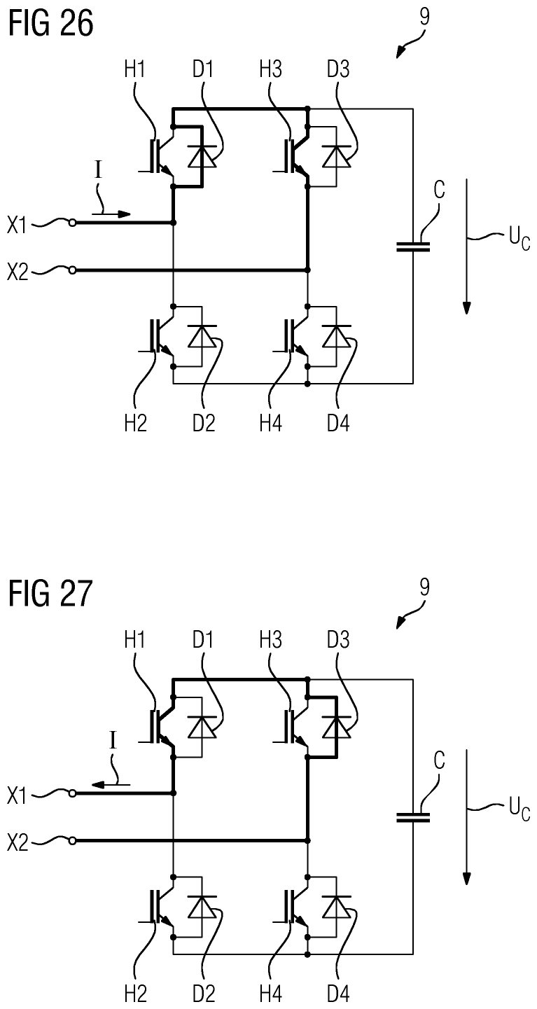

FIG. 26 represents the case in which the third semiconductor switch H3 is in a fault state ON and the switch module 9 is to assume the second switching state in the case of a positive current direction of a current I through the switch module 9. For this purpose, the first, the second and the fourth semiconductor switches H1, H2, H4 are locked. The current I thus flows via the first free-wheeling diode D1 and the third semiconductor switch H3.

FIG. 27 represents the case in which the third semiconductor switch H3 is in a fault state ON and the switch module 9 is to assume the second switching state in the case of a negative current direction of a current I through the switch module 9. For this purpose, the second and the fourth semiconductor switches H2, H4 are locked and the first semiconductor switch H1 is opened. The current I thus flows via the third free-wheeling diode D3 and the first semiconductor switch H1.

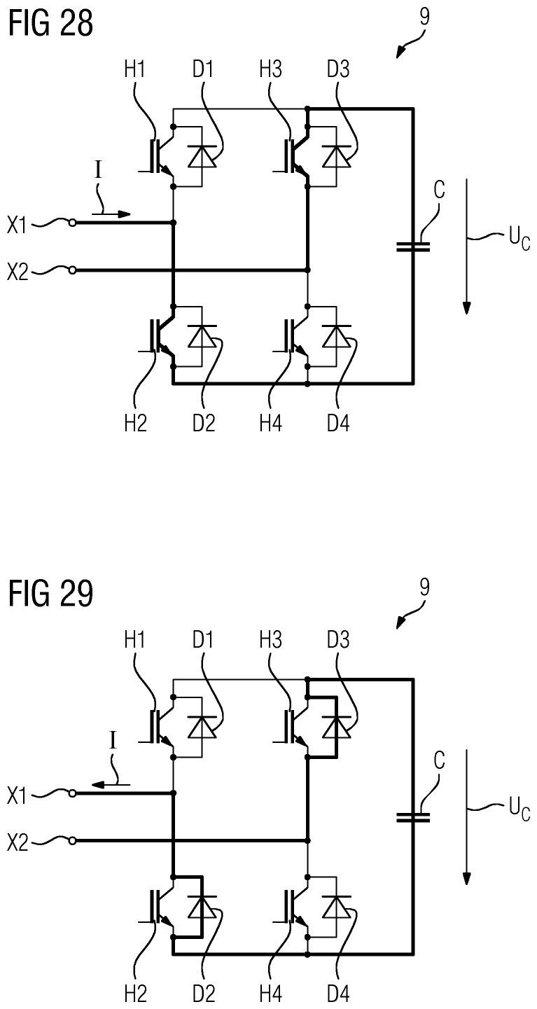

FIG. 28 represents the case in which the third semiconductor switch H3 is in a fault state ON and the switch module 9 is to assume the third switching state in the case of a positive current direction of a current I through the switch module 9. For this purpose, the first and the fourth semiconductor switches H1, H4 are locked and the second semiconductor switch H2 is opened. The current I thus flows via the second and the third semiconductor switches H2 or H3.

FIG. 29 represents the case in which the third semiconductor switch H3 is in a fault state ON and the switch module 9 is to assume the third switching state in the case of a negative current direction of a current I through the switch module 9. For this purpose, the first, the second and the fourth semiconductor switches H1, H2, H4 are locked. The current I thus flows via the second and the third free-wheeling diodes D2 or D3.

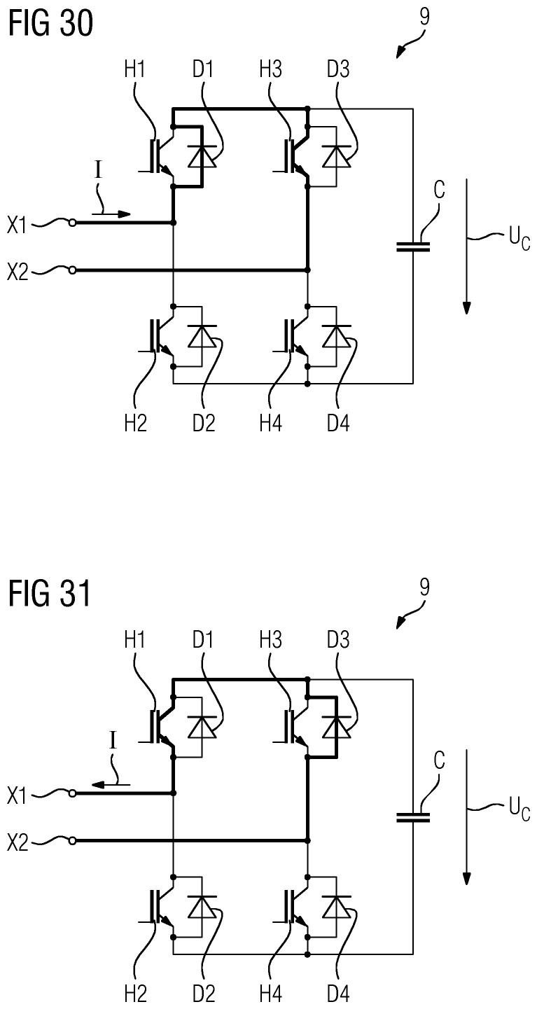

FIG. 30 represents the case in which the fourth semiconductor switch H4 is in a fault state OFF and the switch module 9 is to assume the second switching state in the case of a positive current direction of a current I through the switch module 9. For this purpose, the first and the second semiconductor switches H1, H2 are locked and the third semiconductor switch H3 is opened. The current I thus flows via the first free-wheeling diode D1 and the third semiconductor switch H3.

FIG. 31 represents the case in which the fourth semiconductor switch H4 is in a fault state OFF and the switch module 9 is to assume the second switching state in the case of a negative current direction of a current I through the switch module 9. For this purpose, the second and the third semiconductor switches H2, H3 are locked and the first semiconductor switch H1 is opened. The current I thus flows via the third free-wheeling diode D3 and the first semiconductor switch H1.

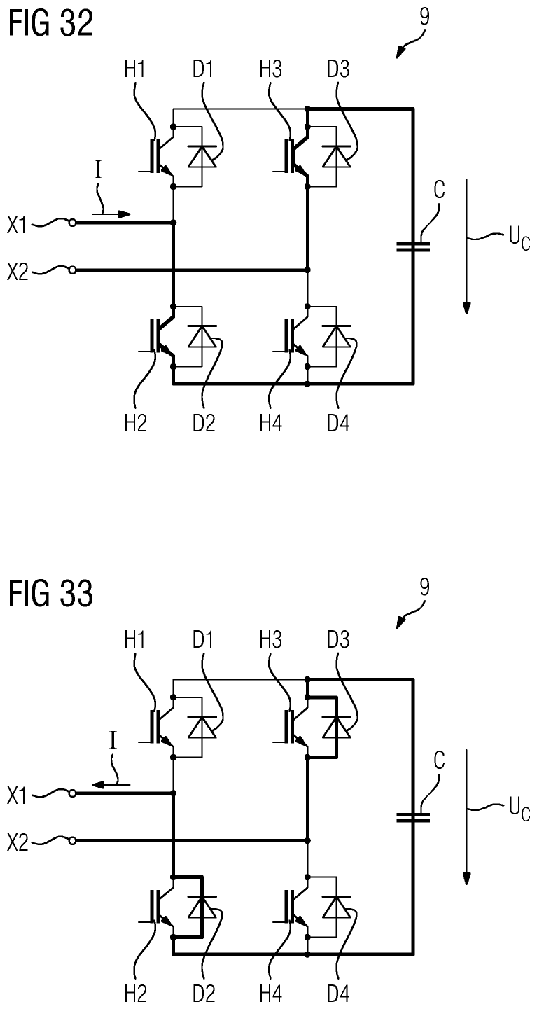

FIG. 32 represents the case in which the fourth semiconductor switch H4 is in a fault state OFF and the switch module 9 is to assume the third switching state in the case of a positive current direction of a current I through the switch module 9. For this purpose, the second and the third semiconductor switches H2, H3 are opened and the first semiconductor switch H1 is locked. The current I thus flows via the second and the third semiconductor switches H2 or H3.

FIG. 33 represents the case in which the fourth semiconductor switch H4 is in a fault state OFF and the switch module 9 is to assume the third switching state in the case of a negative current direction of a current I through the switch module 9. For this purpose, the first, the second and the third semiconductor switches H1, H2, H3 are locked. The current I thus flows via the second and the third free-wheeling diodes D2 or D3.

FIG. 34 shows one example for the procedure for one exemplary embodiment of the method according to the invention in a flow diagram 100.

In a first method step 101, it is established by means of the central control unit that the switch module with the highest currently measured energy storage voltage should be switched next, wherein a positive switch module voltage is to be generated at the switch module which is to be switched.

The subsequent method sequence is then carried out in a loop for all switch modules of a predetermined converter arm.

In a second method step 102, it is queried whether the i-st/nd/rd/th switch module is operated as a half bridge switch module with a negative voltage, wherein i is a number between one and the number of switch modules in the relevant converter arm. In the event that the i-st/nd/rd/th switch module is operated as a half bridge switch module with a negative voltage, the relevant i-st/nd/rd/th switch module is skipped in the selection. In the event that the i-st/nd/rd/th switch module is operated as a full bridge switch module or as a half bridge switch module with a positive voltage, the energy storage voltage of the i-st/nd/rd/th switch module is subsequently determined in a method step 103. After completing the method steps 102 and 103 for all switch modules of the converter arm, the switch module of the ones which have not been skipped is selected which is allocated the highest energy storage voltage and it is switched in a method step 104.

1-10. (canceled)

11. A method for operating a converter arrangement, the method comprising:
providing a converter arrangement including a modular multilevel converter having at least one series connection of double-pole switch modules, the switch modules including at least one first switch module being a full bridge switch module having controllable semiconductor switches and an energy storage device connected to one another in a full bridge circuit; and
after detecting one of the semiconductor switches in the first switch module as being faulty, continuing to operate the first switch module as a half bridge switch module.

12. The method according to claim 11, which further comprises detecting the fault by considering a switch module response having been sent from a control assembly of the first switch module to a central control device of the multilevel converter.

13. The method according to claim 12, which further comprises including in the switch module response at least one of current measurement values or voltage measurement values measured at least at one of the first switch module or one or a plurality of the semiconductor switches.

14. The method according to claim 11, which further comprises determining a fault state of the faulty semiconductor switch and, depending on the determined fault state, operating the first switch module as a half bridge switch module with a positive voltage or as a half bridge switch module with a negative voltage.

15. The method according to claim 14, which further comprises:
providing the first switch module with a first disconnectable semiconductor switch and a first free-wheeling diode connected antiparallel to the first disconnectable semiconductor switch;
providing the first switch module with a second disconnectable semiconductor switch and a second free-wheeling diode connected antiparallel to the second disconnectable semiconductor switch, and connecting the first and second semiconductor switches to one another in a first semiconductor series connection with an identical direction of flow;
providing the first switch module with a third disconnectable semiconductor switch and a third free-wheeling diode connected antiparallel to the third disconnectable semiconductor switch;
providing the first switch module with a fourth disconnectable semiconductor switch and a fourth free-wheeling diode connected antiparallel to the fourth disconnectable semiconductor switch, and connecting the third and fourth semiconductor switches to one another in a second semiconductor series connection with an identical direction of flow;
connecting the first and second semiconductor series connections parallel to one another and to the energy storage device, and providing the first switch module with a first connecting terminal disposed between the semiconductor switches of the first semiconductor series connection, and a second connecting terminal disposed between the semiconductor switches of the second semiconductor series connection;
operating the first switch module as a half bridge switch module with a positive voltage, in an event that the second or the third semiconductor switch is locked in a faulty and permanent manner or the first or the fourth semiconductor switch is open in a faulty and permanent manner; and
operating the first switch module as a half bridge switch module with a negative voltage, in an event that the second or the third semiconductor switch is open in a faulty and permanent manner or the first or the fourth semiconductor switch is locked in a faulty and permanent manner.

16. The method according to claim 11, which further comprises monitoring an energy storage voltage at the energy storage device of the first switch module.

17. The method according to claim 11, which further comprises before switching one of the switch modules, making a selection as to which of the switch modules will be switched next, and for the selection taking into account whether the first switch module is operated as a half bridge switch module with a positive voltage or as a half bridge switch module with a negative voltage.

18. A converter arrangement, comprising:
a modular multilevel converter including at least one series connection of double-pole switch modules, said switch modules including at least one first switch module being a full bridge switch module having controllable semiconductor switches and an energy storage device connected to one another in a full bridge circuit; and
a central control device configured to continue to operate said first switch module as a half bridge switch module after one of said semiconductor switches in said first switch module has been detected as being faulty.

19. The converter arrangement according to claim 17, which further comprises a transformer for connecting the converter arrangement to an AC voltage network.

20. The converter arrangement according to claim 18, wherein said first switch module includes connecting terminals, and a bypass switch is connected to said connecting terminals of said first switch module for bypassing said first switch module.
